(19) United States
(12) Patent Application Publication
(10) Pub. No.: US 2016/0004403 A1
(43) Pub. Date: Jan. 7, 2016

(54) APPARATUS AND METHOD FOR PROCESSING SCROLL INPUT IN ELECTRONIC DEVICE

(71) Applicant: Samsung Electronics Co., Ltd., Gyeonggi-do (KR)

(72) Inventor: Youngsub LEE, Gyeonggi-do (KR)

(21) Appl. No.: 14/742,781

(22) Filed: Jun. 18, 2015

(30) Foreign Application Priority Data
Jul. 2, 2014 (KR) 10-2014-0082620

(51) Int. Cl. G06F 3/0485; G06F 3/0488

(52) U.S. Cl. CPC G06F 3/0485; G06F 3/0488

(57) ABSTRACT

A terminal device and method are disclosed herein. The terminal device includes an input unit for detecting a scroll input, and a controller for executing the method, which includes analyzing the scroll input to detect a scroll step indicating an amount to be scrolled and a direction of movement indicating a scroll direction, and controlling a display of the terminal device to display scrolling of data to a portion of the data corresponding to the scroll step and the scroll direction.

### CLAIM OF PRIORITY

This application claims priority from and the benefit under 35 U.S.C. §119(a) of Korean Patent Application No. 10-2014-0082620, filed on Jul. 2, 2014, which is hereby incorporated by reference for all purposes as if fully set forth herein.

### BACKGROUND

The present disclosure relates to an apparatus and method that processes a scroll input in an electronic device.

### TECHNICAL FIELD

A scroll input in an electronic device may be an input for moving data displayed on a screen. The electronic device may move the data, displayed on the screen, according to a speed of the scroll input. Such a method may be efficient when a small amount of data is displayed.

However, in cases where a large amount of data is displayed, searching for desired data by increasing the scroll speed may not be efficient. For example, when there is a large amount of data, a scroll operation has to be maintained for a long period of time in order to move a visible display portion to the desired data, which may thereby increasing the number of utilized scroll input actions.

### SUMMARY

In various embodiments of the present disclosure, it is possible to discriminatively control the scrolling of data displayed on a display unit according to a user's scroll input.

To this end, an electronic device may analyze the user's usual scroll speed to measure the “step” of an input scroll speed, and when the input speed is higher than an average step, the electronic device may rapidly scroll to a location where data having a higher importance is disposed. Higher importance data that the user frequently uses at ordinary times or determines to be important is situated.

In addition, the electronic device can analyze the pattern of a scroll input to rapidly scroll to a location where data of the higher importance is disposed, according to the analyzed pattern of the scroll input.

Furthermore, the electronic device can analyze the speed and/or pattern of a scroll input and weight values of displayed data and then rapidly scroll to a location of data with higher importance according to the analyzed results.

In one embodiment of this disclosure, a terminal device is disclosed, comprising an input unit for detecting a scroll input, and a controller configured to analyze the scroll input to detect a scroll step indicating an amount to be scrolled, and a direction of movement indicating a scroll direction, and control a display of the terminal device to display scrolling of data to a portion of the data corresponding to the scroll step and the scroll direction.

In another embodiment of this disclosure, a method in a terminal device is disclosed, including detecting, by an input unit of the terminal device, a scroll input, analyzing, by a processor, the scroll input to detect a scroll step indicating an amount to be scrolled, and a direction movement indicating a scroll direction, and displaying by a display of the terminal device scrolling of data to a portion of the data corresponding to the scroll step and the scroll direction.

In situations where there is a large amount of data displayed in an electronic device, a user may easily access a desired data location from among the displayed data utilizing the speed and/or pattern of a scroll input, and weighted values of elements of the displayed data. This method may be used to rapidly scroll data contents, such as documents, e-books, PDF files, as well as data typically arranged a list format, such as a telephone contacts, e-mails, SMS texts, Internet forums or bulletin boards, and the like.

In addition, in cases where an image file, such as a video, includes weight values, an electronic device can execute a rapid scroll function allowing a user to quickly navigate to an interesting portion of the video, or a highlight a particular image within the video.

### BRIEF DESCRIPTION OF THE DRAWINGS

The present disclosure will be more apparent from the following detailed description in conjunction with the accompanying drawings, in which:

FIG. 1 is a block diagram illustrating an example configuration of a terminal device according to various embodiments of the present disclosure;

FIG. 2 is a block diagram illustrating an example configuration for determining a scroll input in the terminal device, according to various embodiments of the present disclosure;

FIG. 3 is a graph for explaining an example operation of determining a scroll step by a speed analysis unit 220;

FIG. 4A and FIG. 4B illustrate example operations in which a pattern analysis unit 230 analyzes the pattern of a scroll input to determine a scroll step;

FIG. 5 is a flowchart illustrating an example method of analyzing a scroll input and executing a scroll in an electronic device according to various embodiments of the present disclosure;

FIG. 6 is a flowchart illustrating an example procedure of determining a scroll step by analyzing the speed of a scroll input;

FIG. 7 is a flowchart illustrating an example procedure of determining a scroll step by analyzing the pattern of a scroll input;

FIG. 8 is a block diagram illustrating an example configuration for determining a scroll input in a terminal device according to another embodiment of the present disclosure;

FIG. 9 is a flowchart illustrating an example method in which a data analysis unit of the terminal device sets weight values of data corresponding to a scroll input;

FIG. 10A and FIG. 10B are views for explaining examples of setting data weight values; and

FIG. 11 is a flowchart illustrating an example procedure in which the terminal device performs a scroll operation using scroll step information and data weight value information.

### DETAILED DESCRIPTION

Hereinafter, the present disclosure will be described with reference to the accompanying drawings. The present disclosure may have various modifications and embodiments and thus will be described in detail with reference to specific embodiments illustrated in the drawings. However, it should be understood that the present disclosure is not limited to the particular embodiments, but includes all modifications, equivalents, and/or alternatives within of the present disclosure. In the description of the drawings, identical or similar reference numerals are used to designate identical or similar elements.

An electronic device, according to various embodiments of the present disclosure, may analyze a user's scroll speed and/or scroll pattern to rapidly move to a location where data that the user wants to discover is situated in a list having data. In addition, the electronic device may analyze data weight values displayed together with the scroll speed and/or the scroll pattern to rapidly scroll to a location where desired data is situated.

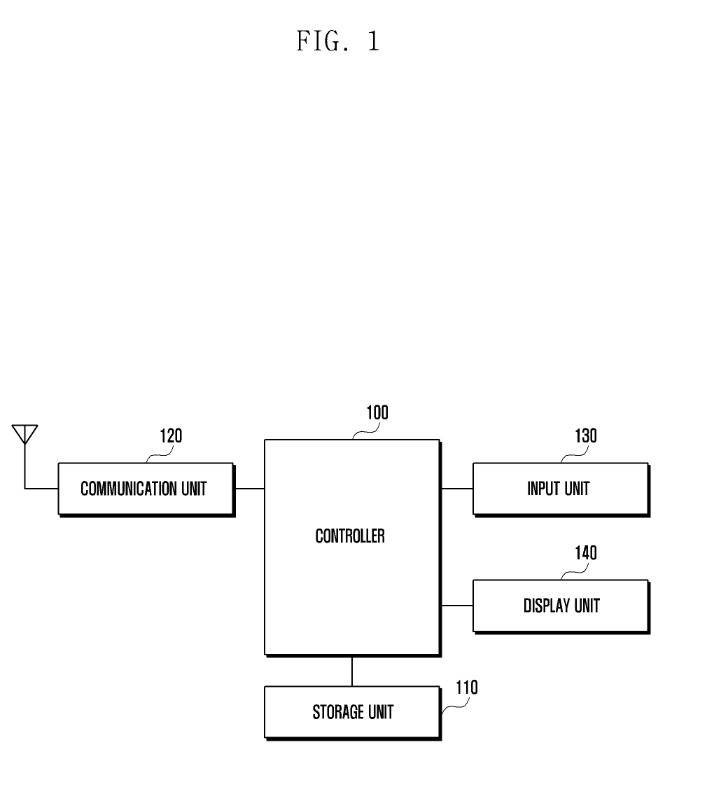

FIG. 1 is a block diagram illustrating a configuration of a terminal device according to various embodiments of the present disclosure. Here, the terminal device may be various types of digital devices, such as mobile phones including smart phones, MP3 terminals, tablet PCs, computers, camera devices, and the like.

Referring to FIG. 1, a communication unit 120 may perform wireless communication with a base station, an Internet server, or the like. The communication unit 120 may be an LTE, WCDMA, CDMA, or GSM communication unit. In addition, the communication unit 120 may be a WIFI or WIMAX type communication unit or an NFC and/or Bluetooth type communication unit. The communication unit 120 may include at least one of the aforementioned communication units. For example, the communication unit 120 may include all of the LTE communication unit, the WIFI communication unit, the Bluetooth communication unit, and the NFC communication unit.

The controller 100 may control the overall operation of the terminal device. In addition, the controller 100 may analyze a scroll input to determine a scroll step and may make a control to scroll to a location corresponding to the determined step to display data. The controller 100 may analyze the scroll input using various parameters. For example, the controller 100 may analyze the scroll input using a scroll speed and/or pattern or weight value information of a scroll movement according to characteristics of displayed data.

A storage unit 110 may include a program memory for storing an operating program of the terminal device and programs according to various embodiments of the present disclosure and a data memory for storing tables for operations of the portable terminal and data generated while the programs are executed.

A display unit 140 may display data under the control of the controller 100 and may scroll the displayed data according to a scroll control of the controller 100. The display unit 140 may be an LCD or an OLED. An input unit 130 may sense a scroll input. The input unit 130 may be a touch panel capable of sensing a touch or hovering of a finger. In addition, the input unit 130 may further include an EMR sensor pad capable of sensing a touch or hovering of a pen. The input unit 130 and the display unit 140 may be integrally formed with each other.

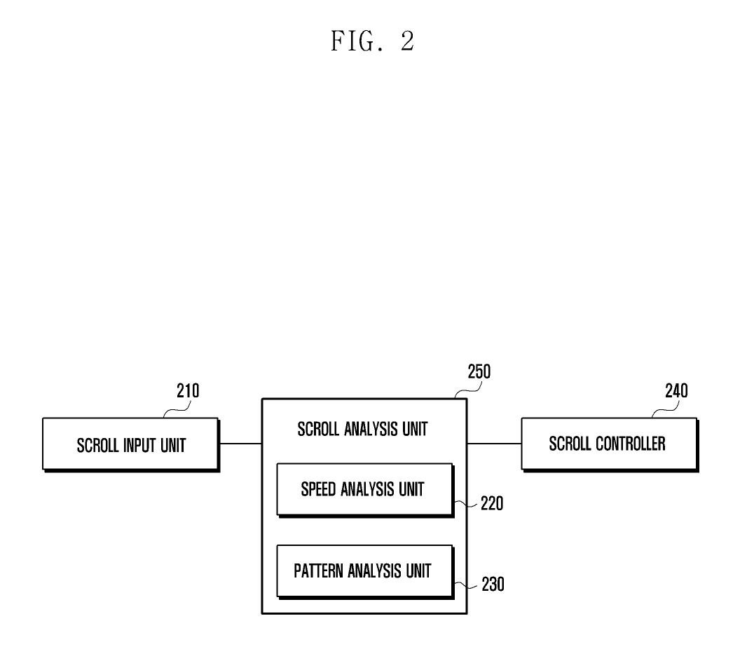

FIG. 2 is a block diagram illustrating a configuration for determining a scroll input in the terminal device, according to various embodiments of the present disclosure. The configuration illustrated in FIG. 2 may be configured in the interior of the controller 100 or may be configured to be independent of the controller 100.

Referring to FIG. 2, the terminal device may include a scroll input unit 210, a scroll analysis unit 250 that analyzes a scroll input to determine a scroll step, and a scroll controller 240 that controls the scrolling of data according to the determined scroll step. The scroll analysis unit 250 may include a speed analysis unit 220 that analyzes the speed of a scroll input to determine a scroll step and/or a pattern analysis unit 230 that analyzes the pattern of a scroll input to determine a scroll step.

The scroll input unit 210 may receive an input of a scroll signal sensed or detected by the input unit 130. Here, the scroll input unit 210 and the input unit 130 may be implemented with the same configuration or may have different configurations. In cases where the scroll input unit 210 and the input unit 130 have different configurations, the scroll input unit 210 may receive an input of a scroll signal among the inputs sensed by the input unit 130. The scroll analysis unit 250 may analyze the scroll input to determine a scroll step. Here, the scroll analysis unit 250 may include the speed analysis unit 220 and/or the pattern analysis unit 230 (as illustrated).

The speed analysis unit 220 may measure the speed of the scroll input generated in the input unit 130 to generate and update a scroll step table, and may determine a step to scroll displayed data, using the measured speed of the scroll input and the scroll step table.

An operation of generating a step table will be described. The speed analysis unit 220 may measure all scroll inputs generated by a user. Based on the measurement result, the speed analysis unit may designate the user's average scroll speed interval and determine a densely distributed section beyond the average scroll speed interval as a fundament scroll step. If a densely distribution section for the speed interval has a higher speed than the fundamental scroll step exists, a higher scroll step interval may be set with an infrequently used speed interval as a boundary.

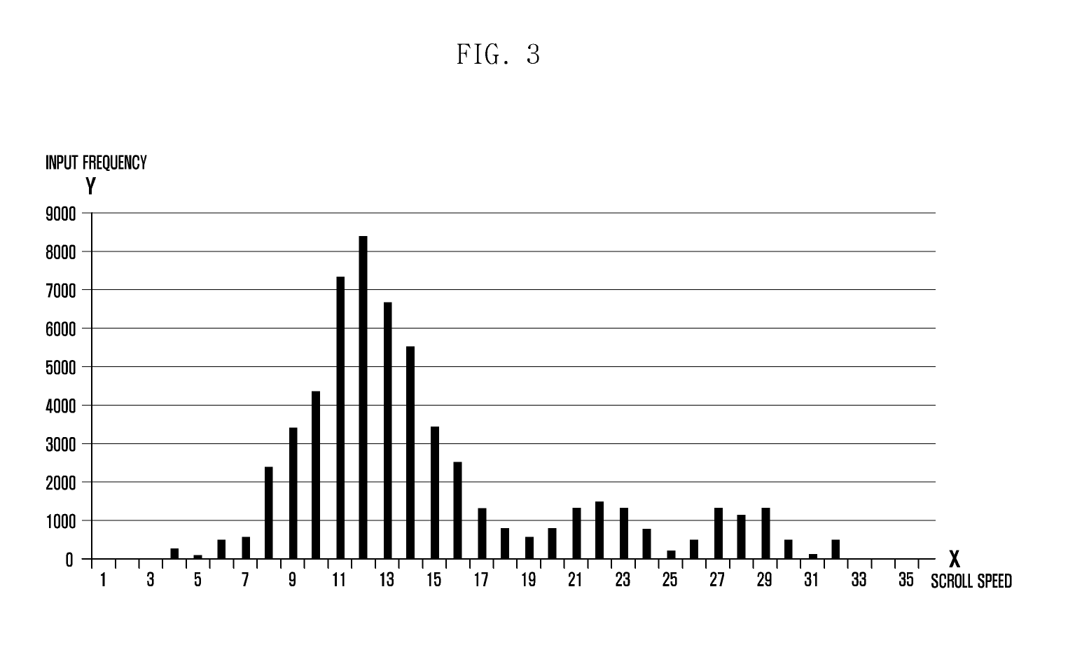

FIG. 3 is a graph for explaining an operation of determining a scroll step by the speed analysis unit 220. In FIG. 3, the horizontal X axis represents measured scroll speeds, and the vertical Y axis represents a scroll input frequency. Referring to FIG. 3, as depicted, an average scroll speed interval may be an interval having a scroll speed of 8 to 19 units. That is, the interval having a scroll input speed of 8 to 19 units may be the most frequently used speed interval. The most frequently used speed interval may be set as a fundamental scroll step. The speed analysis unit 220 may further divide the density data interval beyond the average interval of 8 to 19 units into the first higher scroll step between 19 and 25 units, the second higher scroll step between 25 and 31 units, and the third higher scroll step of 31 units or more. The speed analysis unit 220 may determine a data interval below the first higher scroll step, namely, an interval of 19 units or fewer including the average interval as the fundamental scroll step (such as, for example, the zero step). The speed analysis unit 220 may tabulate the scroll steps depending on the analysis result illustrated in FIG. 3 and update the scroll step table whenever a scroll is input, thereby continually managing the scroll step table.

The speed analysis unit 220, when a scroll is input, may measure the speed of the scroll input and determine a scroll step using the measured speed and the scroll step table. In addition, the speed analysis unit 220 may determine the direction of the scroll input. When the scroll input is generated, the speed analysis unit 220 may measure the speed of the scroll input. The speed of the scroll input may be determined by identifying a length by which the scroll input is maintained (e.g., a length from a touch point to a release point where a touch is released after a scroll on the input unit 130), calculating a travel time from the identified length, and then referring to the length and the time. The speed analysis unit 220 may determine a scroll step from the determined speed of the scroll input with reference to the scroll step table. The speed analysis unit 220 may output the determined scroll step and the direction information to the scroll controller 240.

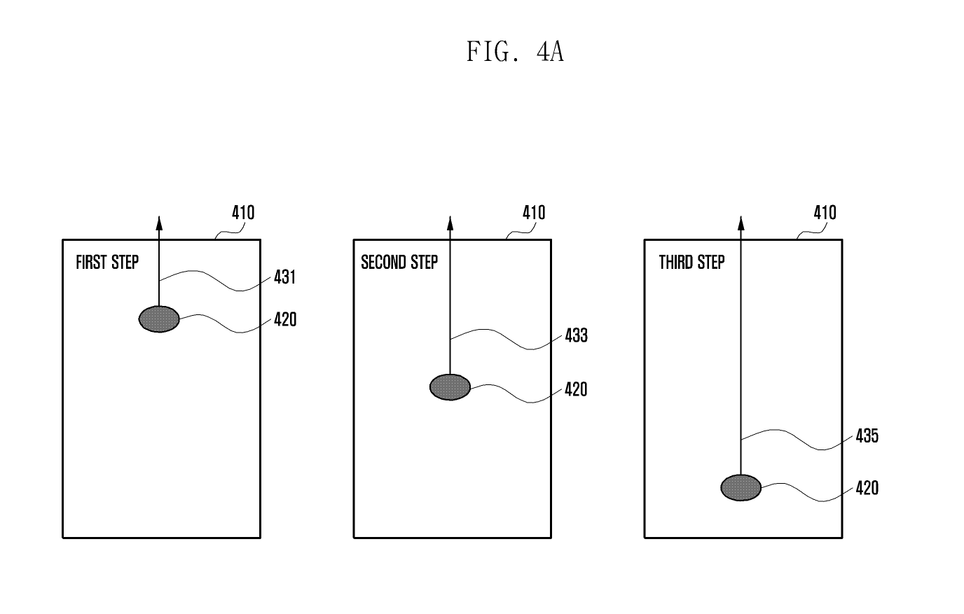

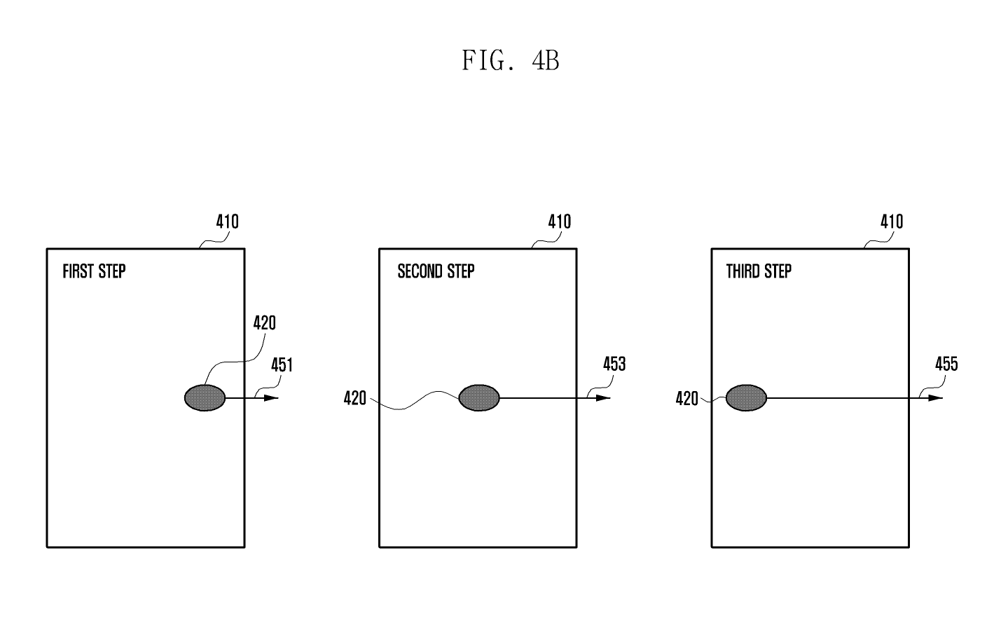

The pattern analysis unit 230 may analyze the pattern of a scroll input to determine a scroll step. The terminal device may determine the step of a scroll input by configuring the pattern analysis unit 230 together with the speed analysis unit 220 or using the pattern analysis unit 230. The pattern analysis unit 230 may be used when a scroll input speed is not clearly distinguished and/or when it is difficult to determine a scroll step depending on a scroll input speed. Referring to FIGS. 4A and 4B, the pattern of the scroll input may be of various types. In the following description, it may be assumed that the pattern of a scroll input is analyzed for whether it contacts the boundary of the touch sensing area, indicating that the scroll input has passed through the boundary between a touch sensing area and a non-touch sensing area of the input unit 130, as illustrated in FIGS. 4A and 4B. FIGS. 4A and 4B thus illustrate example operations in which the pattern analysis unit 230 analyzes the pattern of a scroll input to determine a scroll step.

Referring now to FIG. 4A, when a touch in the touch sensing area of the input unit 130 is dragged beyond a boundary 410, the pattern analysis unit 230 may analyze the length of the scroll input (e.g., reference numerals 431, 433, or 435 of FIG. 4A) to determine a scroll step. Here, the boundary 410 may be the boundary between the touch sensing area and the non-touch sensing area (e.g., a bezel area) of the input unit 130. When a touch, indicated by reference numeral 420, in the touch sensing area passes through the boundary 410 through a scroll operation (as described above), the pattern analysis unit 230 may measure the length of the scroll input to determine a scroll step. For example, when determining the scroll step, the pattern analysis unit 230 may determine the scroll step as the first higher scroll step when the scroll input starts from a point spaced apart from the boundary 410 by a fourth of the length of the full screen as indicated by reference numeral 431, as the second higher scroll step when the scroll input starts from a point spaced apart from the boundary 410 by half the length of the full screen as indicated by reference numeral 433, and as the third higher scroll step when the scroll input starts from a point spaced apart from the boundary 410 by three fourths of the length of the full screen as indicated by reference numeral 435. The distinction of the scroll steps may vary with a user setting.

FIG. 4A illustrates the operation in which the pattern analysis unit 230 determines a scroll step with the scroll input in the up and down direction. In cases where a scroll input is made in the left and right direction, the pattern analysis unit 230 may determine a scroll step through a method illustrated in FIG. 4B. For example, as illustrated in FIG. 4B, the pattern analysis unit 230 may determine the scroll step as the first higher scroll step when the scroll input starts from a point spaced apart from a boundary by a fourth of the width of the full screen as indicated by reference numeral 451, as the second higher scroll step when the scroll input starts from a point spaced apart from the boundary by half the width of the full screen as indicated by reference numeral 453, and as the third higher scroll step when the scroll input starts from a point spaced apart from the boundary by three fourths of the width of the full screen as indicated by reference numeral 455.

However, the scroll input may be detected or generated entirely within the touch sensing area of the input unit 130. For example, the touch input may be released such that the scroll input does not pass through or contact the boundary 410. In these embodiments, the pattern analysis unit 230 may detect the scroll step to be the fundamental scroll step irrespective of the starting point of the scroll input. After determining the scroll step based on the pattern of the scroll input, the pattern analysis unit 230 may output the scroll step and the scroll direction information to the scroll controller 240.

The scroll controller 240 may perform a scroll operation of data displayed on the display unit 140 based on the scroll step and the direction information. Here, the scroll step and the direction information may be output by the scroll analysis unit 250, and the scroll analysis unit 250 may be the speed analysis unit 220 and/or the pattern analysis unit 230. The scroll controller 240 may control the scroll operation of data displayed on the display unit 140 according to the scroll step. The scroll controller 240 may set different scroll lengths depending upon scroll steps. For example, if the scroll step corresponds to the fundamental step, the scroll controller 240 may scroll data by the length of the scroll input. However, if the scroll step corresponds to a higher scroll step, the scroll controller 240 may perform a scroll operation of displayed data to a location corresponding to the relevant higher scroll step. For example, in cases where the higher scroll step includes the first to third steps, the scroll controller 240 may have the first to third scroll execution lengths set to correspond to the first to third steps, respectively. Here, the third execution length may be set to be larger than the second execution length, and the second execution length may be set to be larger than the first execution length. The scroll controller 240, when the scroll step information is received, may scroll data displayed on the display unit 140 by the length set for the corresponding scroll step.

The scroll controller 240 may determine a location to scroll data based on the scroll step information and the direction information which are output from the speed analysis unit 220 and/or the scroll pattern analysis unit 230, and then may scroll data displayed on the display unit 140 to the determined data location.

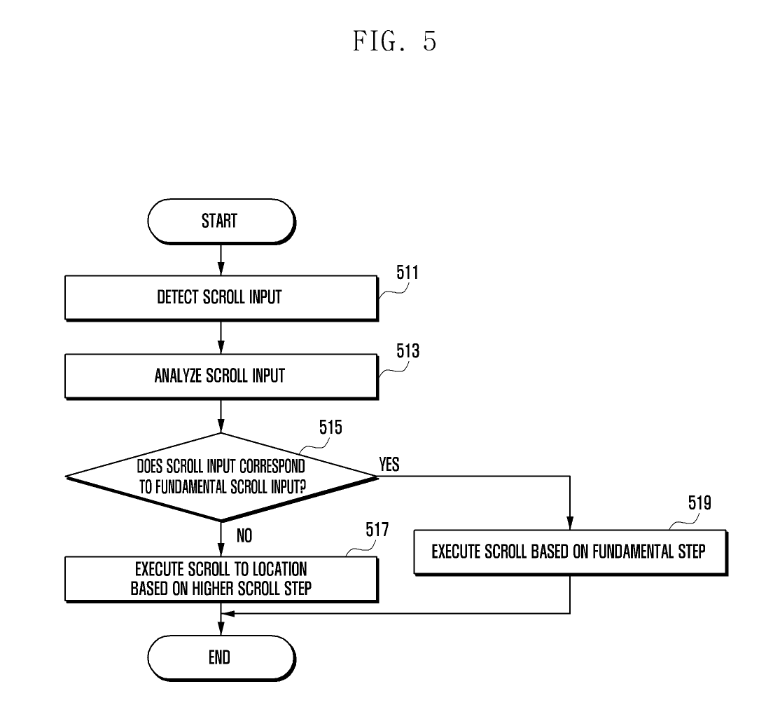

FIG. 5 is a flowchart illustrating an example method of analyzing a scroll input and executing a scroll in an electronic device according to various embodiments of the present disclosure.

Referring to FIG. 5, when a scroll input is generated through the input unit 130, the controller 100 may identify the scroll input in step 511 and analyze the scroll input to determine a scroll step in step 513. At this time, a method of analyzing the speed of the scroll input and/or a method of analyzing the pattern of the scroll input may be used to analyze the scroll input. Then, the controller 100 may analyze the determined scroll step to determine whether the scroll input corresponds to a fundamental step or fundament scroll input, as seen in step 515. When the determined scroll step corresponds to the fundamental step, the controller 100 may scroll data displayed on the display unit 140 by the length corresponding to the scroll input in step 519. However, when it is determined in step 515 that the determined scroll step corresponds to a higher scroll step, the controller 100 may perform a scroll operation to a data location set to correspond to the particular designated higher scroll step in step 517. Here, the higher scroll step may include at least one scroll step. The controller 100 may scroll data displayed on the display unit 140 by the length set to a value of the corresponding higher scroll step and may display the same.

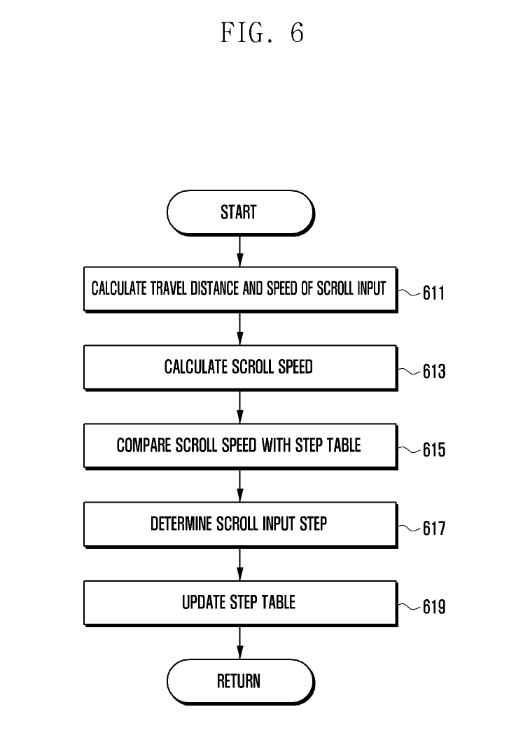

FIG. 6 is a flowchart illustrating an example procedure of determining a scroll step by analyzing the speed of a scroll input. In the example procedure of FIG. 6, a scroll step may be determined or detected by analyzing the speed of the scroll input (e.g., from FIG. 5, step 513).

Referring to FIG. 6, the controller 100 may calculate a travel distance and a travel speed of the scroll input in step 611, and may calculate a scroll speed using the calculated distance and speed in step 613. Here, the scroll speed may be determined by obtaining a length by which the scroll operation has been performed (such as, for example, a distance from a touch point to a release point) and measuring a travel time corresponding to the same length. The controller 100 may then detected the determined scroll speed within a scroll step table in step 615 and determine a scroll step according to the identified value from the scroll step table in step 617.

The controller 100 may update the values of the scroll step table using the scroll speed. In the scroll step table, the most frequently generated speed interval among scroll speeds may be set, and the speed values in the interval set in this way may be set as a fundamental scroll step. An interval having higher scroll speeds than the fundamental scroll step may be set as a higher scroll step. Here, the higher scroll step may include at least one step. For example, if scroll inputs having a scroll speed of 8 to 19 units are most frequently generated as illustrated in FIG. 3, the corresponding speed interval may be set as the fundamental scroll step, and the higher scroll step may be determined by analyzing scroll speeds in a dense speed interval having higher scroll speeds than the fundamental scroll step. For example, among the higher speeds of the scroll inputs illustrated in FIG. 3, the scroll speeds of 25 and 31 units may be infrequently generated scroll speeds. Accordingly, for the scroll inputs having the higher speeds, a scroll speed interval between 19 and 25 units, a scroll speed interval between 25 and 31 units, and a scroll speed interval of 31 units or more may be set as higher scroll steps. The controller 100, after calculating the speed of the scroll input, may accumulate a value depending on the scroll input speed and a frequency, as illustrated in FIG. 3, according to the speed of the corresponding scroll input, and may update the values of the scroll step table according to the accumulated result in step 619.

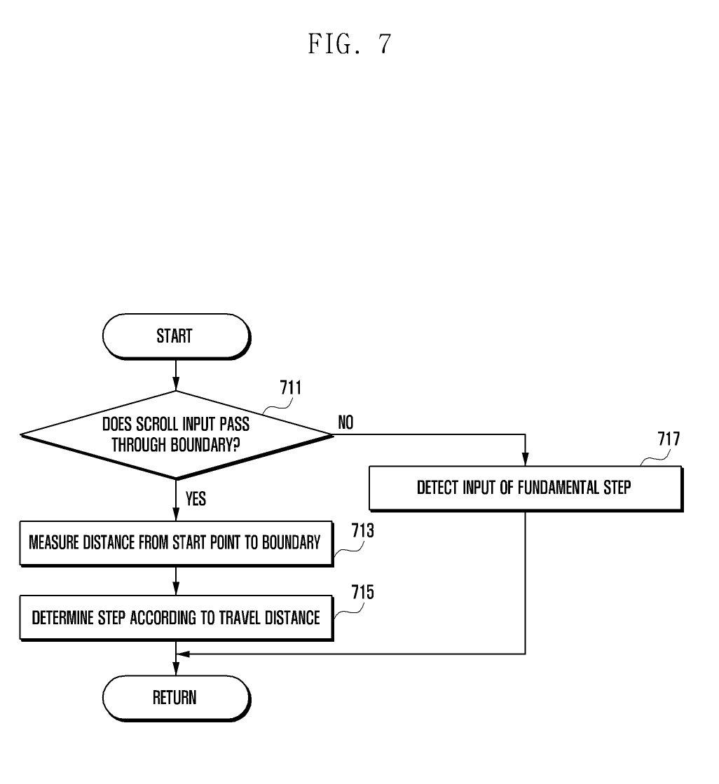

FIG. 7 is a flowchart illustrating an example procedure of determining or detecting a scroll step by analyzing the pattern of a scroll input. In the example procedure of FIG. 7, a scroll step may be determined or detected by analyzing the pattern of the scroll input (e.g., FIG. 5, step 513).

Referring to FIG. 7, the controller may detect in step 711 that a scroll input passes through a boundary, and may then measure the distance from a touch point in the touch sensing area of the input unit 130 to the boundary where the touch input is released in step 713. The controller 100 may determine a scroll step corresponding to the measured distance in step 715. The controller 100 may include a table for detecting the scroll step according to a scroll length. In this case, the length of the vertical scroll illustrated in FIG. 4A may be larger than that of the horizontal scroll illustrated in FIG. 4B, and the scroll step table may be configured with a plurality of tables. The controller 100, when sensing the scroll input, may additionally perform an operation of determining whether the scroll input is a vertical or horizontal scroll input. The vertical or horizontal scroll input may be determined from an input of a non-illustrated sensor (for example, an acceleration sensor, a terrestrial magnetism sensor, or the like).

When the scroll step is determined through the method illustrated in FIG. 6 or 7, the controller 100 may determine the scroll location of data displayed on the display unit 140, using the scroll step and the scroll direction, and may scroll the data to the corresponding location.

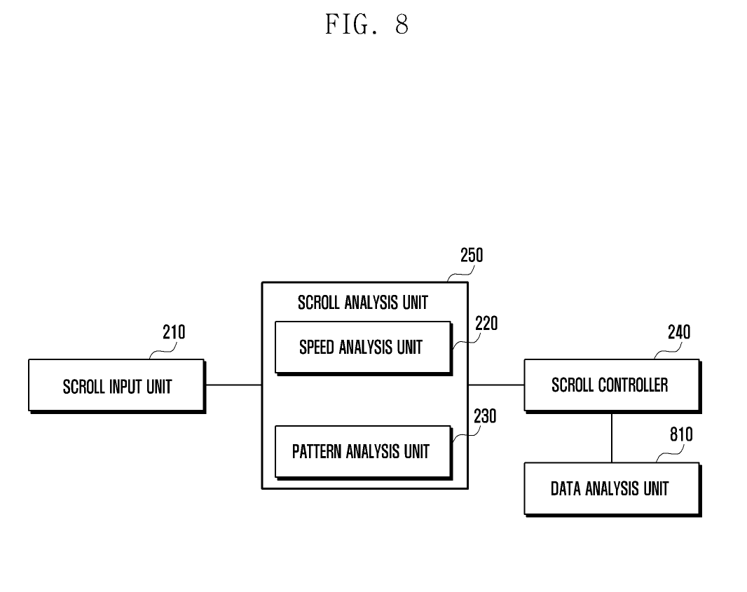

FIG. 8 is a block diagram illustrating a configuration for determining a scroll input in a terminal device according to another embodiment of the present disclosure. The configuration illustrated in FIG. 8 may be configured in the interior of the controller 100 or may be configured to be independent of the controller 100.

Referring to FIG. 8, the terminal device may include a scroll input unit 210, a scroll analysis unit 250 that analyzes a scroll input to determine a scroll step, a data analysis unit 810 that analyzes weight values of data to determine a scroll location of the data displayed on the display unit 140, and a scroll controller 240 that controls the scrolling of the data according to the determined scroll step and the data weight values. The scroll analysis unit 250 may include a speed analysis unit 220 that analyzes the speed of a scroll input to determine a scroll step and/or a pattern analysis unit 230 that analyzes the pattern of a scroll input to determine a scroll step.

The scroll input unit 210 may receive an input of a scroll signal sensed by the input unit 130. Here, the scroll input unit 210 and the input unit 130 may have the same configuration or different configurations. In cases where the scroll input unit 210 and the input unit 130 have different configurations, the scroll input unit 210 may receive an input of a scroll signal among the inputs sensed by the input unit 130. The scroll analysis unit 250 may analyze the scroll input to determine a scroll step. Here, the scroll analysis unit 250 may include the speed analysis unit 220 and/or the pattern analysis unit 230, as depicted here in FIG. 8. However, in other embodiments the scroll analysis unit may include either the speed analysis unit 220 or the pattern analysis unit 230, but not both.

The speed analysis unit 220 may measure the speed of the scroll input generated in the input unit 130 to generate and update a scroll step table, and may determine a step to scroll data using the measured speed of the scroll input and the scroll step table. The pattern analysis unit 230 may analyze the pattern of a scroll input to determine a scroll step. As described above, the terminal device may determine the step of a scroll input by configuring the pattern analysis unit 230 together with the speed analysis unit 220 or using the pattern analysis unit 230. The pattern analysis unit 230 may be used when a scroll input speed is not clearly distinguished and/or when it is difficult to determine a scroll step depending on a scroll input speed.

The data analysis unit 810 may analyze weight values of data displayed on the display unit 140 to create a data classification table. The data weight values may be determined by a running application. For example, if the running application is a data list (e.g., a phone book list, an e-mail list, an SNS list, or the like), use frequencies may be set as data weight values, and if the running application is an application that displays text (e.g., an electronic book, a paper, a Web page, or the like), contents (e.g., an index) for the text may be set as data weight values. The data analysis unit 810 may determine location information for scrolling data of an executed application according to scroll steps (e.g., weight values by which a scroll location varies with steps).

The scroll controller 240 may determine a location of data to execute a scroll operation using the weight value information output from the data analysis unit 810 and the scroll step/direction information output from the scroll analysis unit 250, and may move, for example, a displayed list to the corresponding location.

Data displayed on the display unit 140 may have different use frequencies or may be classified according to items. Accordingly, it may be effective to scroll the data utilizing weight values that correlate to the use frequencies or items. The weight values may be determined using several numerical values. For example, in the case of a telephone book, a higher weight value may be set for data of a person whom a user frequently calls at ordinary times, and in the case of mail, a higher weight value may be set for mail sent by a sender whom a user has marked with many symbols of importance.

The data analysis unit 810 may determine or detect weight values by analyzing data displayed on the display unit 140 and then mapping the data weight values with detected scroll steps for the data. At this time, the data weight values may be mapped to correspond to scroll steps, as determined by the scroll analysis unit 250. For example, in cases where a higher scroll step includes the first to third steps, the data weight values may also be set to three steps.

In another example, when the weight value of data displayed on the display unit 140 is the top 30%, the data analysis unit 810 may map the corresponding data with the first step, and when the weight value of data displayed on the display unit 140 is the top 20%, the data analysis unit 810 may map the corresponding data with the second step. In addition, when the weight value of data displayed on the display unit 140 is the top 10%, the data analysis unit 810 may map the corresponding data with the third step. At this time, the percentage value may be adjusted according to characteristics of the data and a user. For data higher than or equal to the first scroll step, the data analysis unit 810 may create a weight value table, such as the one shown below as Table 1. Such a table may be generated using step information that is classified on the basis of location information and weight values of the data. For example, the data analysis unit 810 may create the weight value table, such as the one seen below in Table 1, to output the same to the scroll controller 240.

TABLE 1

| Row | Step |
|---|---|
| 15 | 1 |
| 27 | 2 |
| 51 | 1 |
| 72 | 1 |
| 80 | 2 |
| 95 | 3 |
| 103 | 2 |
| 121 | 2 |
| 135 | 1 |
| 152 | 1 |

As shown in Table 1 above, the scroll controller 240 may scroll data displayed on the display 140 according to input scroll step information of the table. For example, if successively receiving five pieces of first scroll step information, the scroll controller 240 may perform a scroll operation for movement to the 15^{th}, 27^{th}, 51^{th}, 72^{th}, and 80^{th} row positions of the data when scrolling the data. However, if successively receiving two pieces of second scroll step information, the scroll controller 240 may perform a scroll operation for movement to the 27^{th} and 80^{th} row positions of the data when scrolling the data. In addition, if receiving the third scroll step information, the scroll controller 240 may perform a scroll operation for movement to the 95^{th} row position of the data when scrolling the data. Furthermore, if sequentially receiving the second and first scroll step information, the scroll controller 240 may perform a scroll operation for movement to the 27^{th} and 51^{th} row positions of the data when scrolling the data.

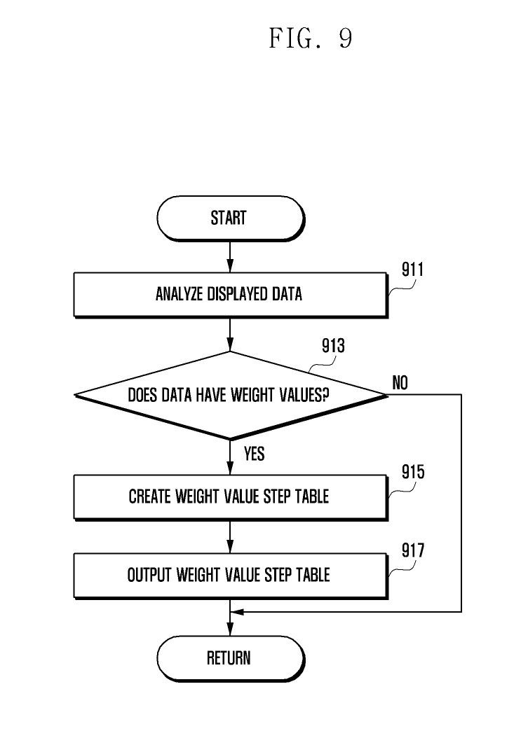

FIG. 9 is a flowchart illustrating an example method in which the data analysis unit of the terminal device sets weight values of data corresponding to a scroll input.

In step 911, the data analysis unit 810 may analyze data displayed on the display unit 140. The data analysis unit 810 may analyze the type of data to identify whether the data has weight values. If the data has weight values, the data analysis unit 810 may create a weight value step table in step 915, (such as Table 1 above), and output the created weight value table to the scroll controller 240 in step 917.

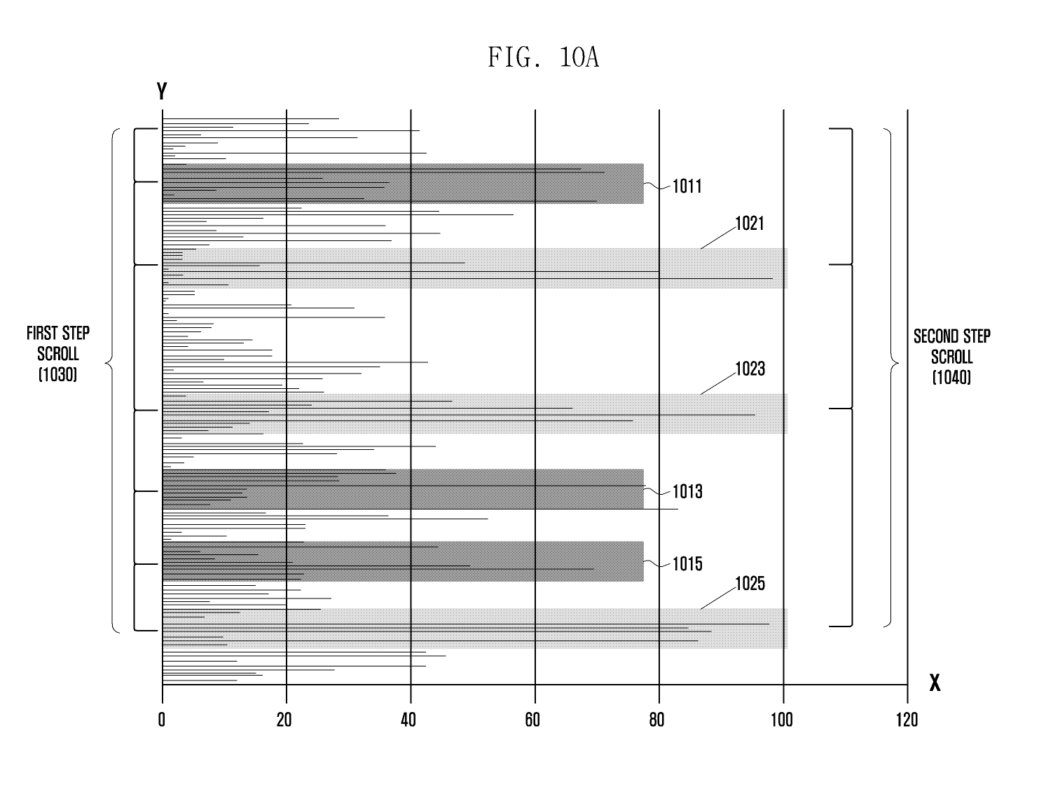

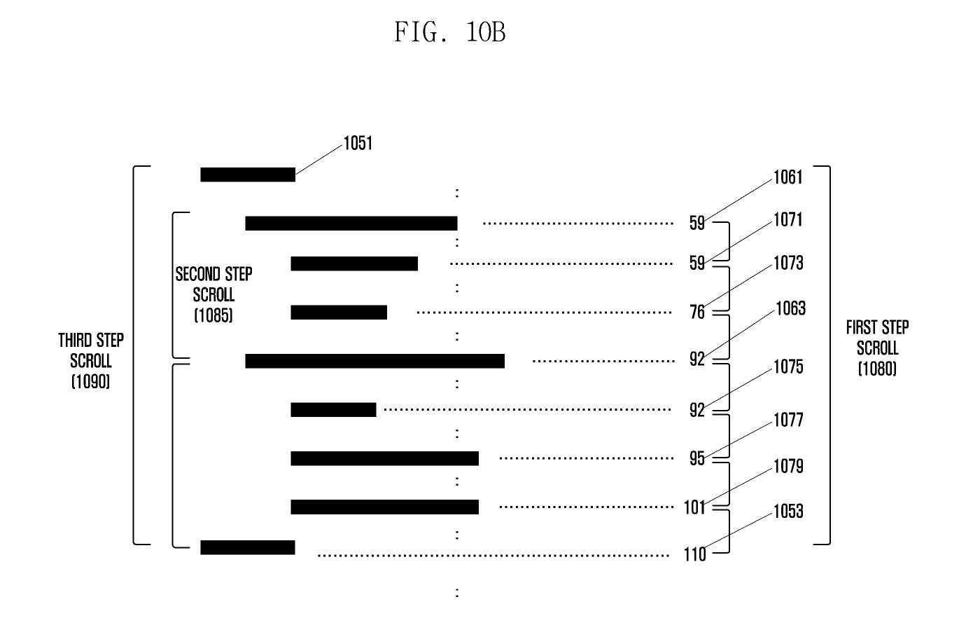

FIGS. 10A and 10B are example illustrations showing examples of setting data weight values. Data classification methods according to weight values of data may vary according to the type of a document. In various embodiments of the present disclosure, the data analysis unit 810 may classify data into data including use frequencies, data including content, and data lacking weight values.

First, referring to FIG. 10A, a data classification method according to use frequencies may include assigning weight values to data (e.g., particular entries within the data)which a user frequently searches for, and classifying weight value steps for the data using the weight values. For example, for data in a list form, such as a telephone book, weight values may be calculated in view of the number of times that a user makes a call or receives a call from a particular user. The data analysis unit 810 may map the weight values with scroll steps as illustrated in FIG. 10A. FIG. 10A illustrates an example of measuring data weight values according to use frequencies of phone numbers and mapping a particular range of the weight values with scroll steps in the case of a telephone number list (e.g., by using a predetermined range of the weight values). In FIG. 10A, reference numerals 1011, 1013, and 1015 may be weight values of data mapped with the first scroll step, and reference numerals 1021, 1023, and 1025 may be weight values of data mapped with the second scroll step.

When the weight values are determined as illustrated in FIG. 10A, the scroll controller 240 may scroll data displayed on the display 140 according to input scroll step information. For example, when the first scroll step information is successively input, the scroll controller 240 may perform a scroll operation in sequence of reference numerals 1011, 1021, 1023, 1013, 1015, and 1025 when scrolling the data. However, when the second scroll step information is successively input, the scroll controller 240 may perform a scroll operation in sequence of reference numerals 1021, 1023, and 1025 when scrolling the data.

Therefore, when higher scroll step (e.g., second step) information is input, the scroll controller 240 may perform a scroll operation to a location of frequently used data.

Referring to FIG. 10B, FIG. 10B illustrates a data classification method wherein data is classified according to content. The method may be implemented for data (e.g., a document) that includes the contents, in which weight values of the data may be measured using the contents. Most data, such as documents or e-books, includes content information. Even when data does not include content information, paragraphs or chapters may be classified by other means (e.g., line spacing, tabs or indentations, or the like) instead of content. Therefore, for data classified as a book or a paper, weight values may be determined by paragraphs, chapters, or a title, and the determined weight values may be mapped with scroll steps. In FIG. 10B, reference numerals 1071 to 1079 may be data weight values mapped with the first scroll step, reference numerals 1061 and 1063 may be data weight values mapped with the second scroll step, and reference numerals 1051 and 1053 may be data weight values mapped with the third scroll step. A data weight value table like Table 1 above may be created using the weight values determined as illustrated in FIG. 10B.

When the weight values are determined as illustrated in FIG. 10B, the scroll controller 240 may scroll data displayed on the display 140 according to input scroll step information. For example, when the first scroll step information is received, the scroll controller 240 may scroll data in sequence of reference numerals 1051, 1061, 1071, 1073, 1063, 1075, . . . etc. When the second scroll step information is successively received, the scroll controller 240 may execute a scroll in sequence of reference numerals 1051, 1061, 1063, and 1053, etc., when scrolling the data. In addition, when the third scroll step information is successively received, the scroll controller 240 may execute a scroll in sequence of reference numerals 1051 and 1053 when scrolling the data. Furthermore, for situations in which data does not include a weight value, the scroll methods described above cannot be used. In this case, the data analysis unit 810 may not transfer a data weight value step table to the scroll controller 240. The scroll controller 240 may use the scroll step information and the direction information, such that scrolling of the data may be executed according to an amount or size of scrolling pre-set for each scroll step.

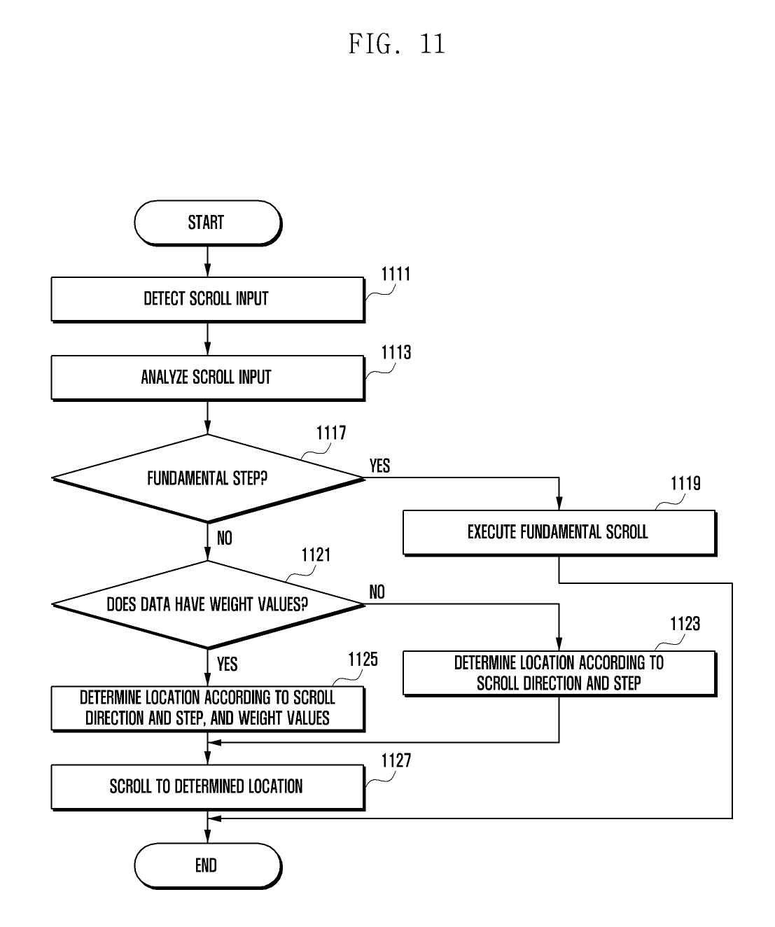

FIG. 11 is a flowchart illustrating a procedure in which the terminal device performs a scroll operation using scroll step information and data weight value information.

Referring to FIG. 11, when a scroll input is generated in step 1111, the controller 100 may analyze the scroll input to determine a scroll step and direction in step 1113. Here, the scroll step may be determined by analyzing the speed and/or pattern of the scroll input.

In cases where the scroll step is determined by analyzing the speed of the scroll input, a scroll step table may be used to determine the scroll step according to the speed of the scroll input. The scroll step table may be a constant scroll step table or a table in which scroll step table values for determining a scroll step are updated according to a scroll speed. An operation of updating the scroll step table values will be described. The controller 100, when a scroll input is generated, may measure the speed of the scroll input. The speed of the scroll input may be determined using a scrolled distance and a travel speed along the corresponding distance. When speeds of scroll inputs are collected a predetermined number of times or more, the controller 100 may analyze the mean value of the scroll inputs and create a scroll step table by analyzing the scroll speeds higher than a group of mean data. The values of the scroll step table may be updated whenever the speed of the scroll input is measured. At this time, the speed of the scroll input may be measured through the method illustrated in FIG. 3, and the scroll step table may be created and updated using the measured speed.

The controller 100 may analyze the scroll input to determine a scroll step. The scroll step may be determined by analyzing the speed or pattern of the scroll input. Here, a method of determining the scroll step using the speed of the scroll input may be executed through the method illustrated in FIG. 6, and a method of determining the scroll step using the pattern of the scroll input may be executed through the method illustrated in FIG. 7. In addition, the scroll step may also be determined by measuring both the speed and the pattern of the scroll input. When the scroll input is generated in step 1111, the controller 100 may analyze the speed and the pattern of the scroll input in step 1113. For example, the controller 100 may measure the speed of the scroll input and determine a scroll step corresponding to the measured speed in the scroll step table. When the scroll input passes through the boundary of the touch sensing area of the input unit 130, the controller 100 may analyze the pattern of the scroll input, measure the length of the analyzed scroll pattern (the distance from a touch start point to the boundary), and determine a scroll step corresponding to the measured length.

After determining the scroll step and direction by analyzing the scroll input as described above, the controller 100 may, in step 1117, identify whether the scroll step is a fundamental step. As described earlier, the fundamental step is a scroll step determined by the most frequently used speed for scroll inputs, or when the pattern of the scroll input is generated in the touch sensing area of the input unit 130. When it is determined that the scroll step is the fundamental step, the controller 100 may perform a scroll operation movement the visible displayed data an amount according to the current scroll input, and not by a size set by the scroll step table. Therefore, when it is determined that the scroll input is the fundamental step, the controller 100 may proceed to step 1119 to control movement and display of the data displayed on the display unit 140 using the fundamental scroll operation.

However, when it is determined that the scroll input is not the fundamental step, it may mean that the scroll input has a value of a higher scroll step (such as, for example, any one of the first to the n^{th} steps). Then, the controller 100 may detect the scroll input being of the higher scroll step in step 1117, and may identify whether the data displayed on the display unit 140 has weight values in step 1121. The data weight value analysis may be determined according to the type and attribute of data as described above. For example, in cases where the data displayed on the display unit 140 is data in a list form (e.g., phone numbers or e-mail), data weight values may be determined according to the number of times that a user has accessed the data, or in cases where the data displayed on the display unit 140 is data arranged according to a predetermined rule (e.g., an electronic book), data weight values may be determined according to the items arranged according to the rule. The data displayed on the display unit 140 may not have weight values.

When the data does not have weight values, the controller 100 may detect this in step 1121, determine the location of data to scroll according to the scroll step and direction in step 1123, and scroll the data to the determined location in step 1127. However, in cases where the data does have weight values, the controller 100 may sense this in step 1121, determine the scroll location of data in view of the scroll step, the weight values of the data, and the scroll direction in step 1125, and scroll the data to the determined location in step 1127.

The controller 100 may analyze the speed and/or pattern of the scroll input to determine the scroll step, and may create a data weight value step table collected according to the data analysis result when there are data weight values. When the scroll input is determined as the fundamental step, the controller 100 may move the data displayed on the display unit 140 on the basis of the speed of the scroll input irrespective of the weight values of the data.

In cases where the scroll step is higher than the fundamental step, but the data does not have weight values (i.e., there is no data weight value step table), the controller 100 may scroll the data by a given value for each scroll step. For example, in cases where the scroll step is higher than the fundamental step, there are no data weight values, and when the data is an electronic book), the controller 100 may scroll the data using a set page size (e.g., five pages in the first step, ten pages in the second step, twenty pages in the third step, and the like). In addition, in cases where the scroll step is higher than the fundamental step, there are no data weight values, and data is video data, the controller 100 may scroll the data using set time (e.g., ten seconds in the first step, one minute in the second step, ten minutes in the third step, and the like).

In cases where the scroll step is higher than the fundamental step and a data weight value step table is given, the controller 100 may select the next point from the data weight value step table using the direction of the scroll and then scroll data to the location of data having a weight value step higher than or equal to the scroll step. For example, in cases where the scroll step is the second step, the controller 100 may scroll the data by one item according to the first step data and the weight values in the data weight value analysis table, and when the scroll step satisfies the second or third step data, the controller 100 may scroll the data to a portion of the data where the portions of the data matching the data weight from the value analysis table is located.

Embodiments of the present disclosure in the specification and the drawings are particular examples to easily describe the technical matters of the present disclosure and assist for understanding of the present disclosure, but do not limit the present disclosure. It is apparent to those skilled in the art that other modified examples based on the technical idea of the present disclosure can be implemented as well as the embodiments disclosed herein.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A terminal device comprising:
an input unit for detecting a scroll input; and
a controller configured to:
analyze the scroll input to detect a scroll step indicating an amount to be scrolled, and a direction of movement indicating a scroll direction; and
control a display of the terminal device to display scrolling of data to a portion of the data corresponding to the scroll step and the scroll direction.

2. The terminal device of claim 1, wherein the controller is further configured to:
detect a speed of the scroll input; and
detect the scroll step by comparing the detected speed with speed values stored in a scroll step table,
wherein scroll steps of the scroll step table include a fundamental scroll step indicating a default amount the data is to be scrolled, and at least one higher scroll step indicating a greater amount the data is to be scrolled than the default amount.

3. The terminal device of claim 2, wherein the controller is further configured to aggregate detected speeds of the scroll input as detected by the input unit to update the scroll step table.

4. The terminal device of claim 2, wherein the controller is further configured to:
detect the scroll step as the fundamental step when an entirety of the scroll input is detected within an input area of the input unit; and
detect the scroll step as the higher scroll step when a length of the scroll input contacts a boundary of the input area indicating that the scroll input has passed through the boundary of the input area.

5. The terminal device of claim 2, wherein the controller is further configured to control the display to scroll the data to the portion of the data corresponding to the scroll direction and the scroll step to display the portion of the data on the display.

6. The terminal device of claim 2, wherein the data comprises a plurality of entries, each entry associated with a weight value, the controller further configured to:
classify the plurality of entries into predetermined weight value ranges according to their respective associated weight values; and
map the classified plurality of entries to a plurality of scroll steps based on the predetermined weight value ranges.

7. The terminal device of claim 6, wherein the respective weight values for each of the plurality of entries is based on a respective use frequency of each of the plurality of entries.

8. The terminal device of claim 6, wherein the respective weight values for each of the plurality of entries is based on content of each of the plurality of entries of the data.

9. The terminal device of claim 7, wherein when the data does not include weight values for the plurality of entries, scrolling the data is executed according to a preset amount of scrolling.

10. A method in a terminal device comprising:
detecting, by an input unit of the terminal device, a scroll input;
analyzing, by a processor, the scroll input to detect a scroll step indicating an amount to be scrolled, and a direction movement indicating a scroll direction; and
displaying by a display of the terminal device scrolling of data to a portion of the data corresponding to the scroll step and the scroll direction.

11. The method of claim 10, wherein detecting the scroll step further comprises detecting a speed of the scroll input and comparing the detected speed with values in a scroll step table, and wherein scroll steps of the scroll step table include a fundamental scroll step indicating a default amount the data is to be scrolled, and at least one higher scroll step indicating a greater amount the data is to be scrolled than the default amount.

12. The method of claim 11, further comprising aggregating detected speeds of the scroll input as detected by the input unit to update the scroll step table.

13. The method of claim 11, further comprising:
detecting the scroll step as the fundamental step when an entirety of the scroll input is detected within an input area of the input unit; and
detecting the scroll step as the higher scroll step when a length of the scroll input contacts a boundary of the input area indicating that the scroll input has passed through the boundary of the input area.

14. The method of claim 11, further comprising: scrolling the data to the portion of the data corresponding to the scroll direction and the scroll step to display the portion of the data on the display.

15. The method of claim 11, wherein the data comprises a plurality of entries, each entry associated with a weight value, the method further comprising:
classifying the plurality of entries into predetermined weight value ranges according to their respective associated weight values; and
mapping the classified plurality of entries to a plurality of scroll steps based on the predetermined weight value ranges.

16. The method of claim 15, wherein the respective weight values for each of the plurality of entries is based on a respective use frequency of each of the plurality of entries.

17. The method of claim 15, wherein the respective weight values for each of the plurality of entries is based on content of each of the plurality of entries of the data.

18. The method of claim 16, wherein when the data does not include weight values for the plurality of entries, scrolling the data is executed according to a preset amount of scrolling.
